(19) United States
(12) Patent Application Publication
(10) Pub. No.: US 2026/0109371 A1
(43) Pub. Date: Apr. 23, 2026

(54) APPARATUS AND METHOD FOR DISPLAYING TRAFFIC LIGHT INFORMATION IN VEHICLE

(71) Applicants: Hyundai Motor Company, Seoul (KR); Kia Corporation, Seoul (KR)

(72) Inventors: Dong Hyun Lim, Hwaseong (KR); Soo Yeon Shin, Hwaseong (KR)

(21) Appl. No.: 19/200,976

(22) Filed: May 7, 2025

(30) Foreign Application Priority Data
Oct. 21, 2024 (KR) 10-2024-0144383

(51) Int. Cl. B60W 50/14; B60K 35/28; G06V 10/82; G06V 20/58; H04W 4/44

(52) U.S. Cl. CPC B60W 50/14; B60K 35/28; G06V 10/82; G06V 20/584; H04W 4/44; B60K 2360/166; B60K 2360/188; B60K 2360/191; B60K 2360/589; B60W 2050/146; B60W 2420/403; B60W 2552/53; B60W 2555/60; B60W 2556/45

(57) ABSTRACT

An apparatus and a method for displaying traffic light information incorporate a communication module that receives at least one of vehicle information, infrastructure information, surrounding vehicle information, driving route information, vehicle location information, or traffic light data using vehicle-to-everything (V2X) communication, a camera module that receives a front view camera image, an output module that displays the traffic light data on a display, and a processor that controls to select a target traffic light for guidance, extract the target traffic light for guidance from an image in the front view camera image, and overlay and output the traffic light data with the target traffic light for guidance in the front view camera image on a navigation monitor.

### CROSS-REFERENCE TO RELATED APPLICATION

This application claims under 35 U.S.C. § 119(a) the benefit of Korean Patent Application No. 10-2024-0144383, filed in the Korean Intellectual Property Office on Oct. 21, 2024, the entire contents of which are incorporated herein by reference.

### BACKGROUND

### (a) Technical Field

The present disclosure relates to technologies for displaying traffic light information together in providing navigation information using a front view camera image.

### (b) Description of the Related Art

In general, the driving of a vehicle should be in accordance with signals of traffic lights encountered during driving. However, in certain situations, it may be difficult for a driver to determine which traffic light(s) should be observed at an intersection.

For example, if there are several traffic lights around a vehicle at an intersection such as crossroads or a five-way intersection, it may be difficult for the driver to identify which traffic lights the driver should comply with, and the driver's attention may be distracted in the process of identifying the appropriate traffic light(s).

For another example, if it is difficult for the driver to keep his or her eyes on the road, for example, if the sun shines in the driver's eyes, it may be difficult for the driver to identify traffic lights around the vehicle.

Furthermore, if displaying navigation information using a front view camera image, it may be difficult for the driver to accurately identify traffic light information due to an external environment, a graph device issue, or the like.

Furthermore, in general, the driver of the vehicle which is stopping according to the red light of the traffic lights should keep a close eye on the traffic lights, until the traffic lights change to the green light. Due to this, the fatigue of the driver is aggravated.

Due to such causes, a technology and a system for delivering information about traffic lights around a vehicle to a driver have been introduced.

### SUMMARY

An aspect of the present disclosure provides a method for addressing visibility of traffic lights so as to display the traffic light(s) on a navigation monitor depending on an external environment, such as a dark night, a dark tunnel, the inside of an underpass, or inclement weather such as heavy rain.

Another aspect of the present disclosure provides a method for allowing a color-blind driver to accurately recognize signal information of traffic lights in augmented reality image displayed on a navigation monitor.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, an apparatus for displaying traffic light information in a vehicle includes: a communication module configured to receive at least one of vehicle information, infrastructure information, surrounding vehicle information, driving route information, vehicle location information, or traffic light data using vehicle-to-everything (V2X) communication; a camera module configured to receive a front view camera image; an output module configured to display the traffic light data on a display of a vehicle; and a processor configured to control to select at least a target traffic light for guidance, extract the target traffic light for guidance from an image in the front view camera image, and overlay and output the traffic light data with the target traffic light for guidance in the front view camera image on a navigation monitor.

According to a further aspect, an apparatus for displaying traffic light information may be provided to include a communication module that receives vehicle information, infrastructure information, surrounding vehicle information, driving route information, vehicle location information, and at least one piece of traffic light data using vehicle-to-everything (V2X) communication, a camera module that receives a front view camera image, an output module that displays the traffic light data on a display, and a processor that controls to select target traffic lights for guidance, extract the target traffic lights for guidance from an image in the front view camera image, and overlay and output the traffic light data with one side of the target traffic lights for guidance in the front view camera image on a navigation monitor.

According to an embodiment, the apparatus may be provided to further include a navigation module that receives driving route data of a vehicle.

According to an embodiment, the apparatus may be provided such that the processor may control to output at least one of traffic lights color information or a red light message at one side of first traffic lights in front of the vehicle, if a driving route of the vehicle is a straight route and the first traffic lights are a red light.

According to an embodiment, the apparatus may be provided such that the processor may control to output red light remaining time information of the first traffic lights together at the one side of the first traffic lights.

According to an embodiment, the apparatus may be provided such that the processor may control to highlight and output an image of second traffic lights which changes before the first traffic lights change to a green light.

According to an embodiment, the apparatus may be provided such that the processor may control to generate traffic lights color information of a crosswalk located on a right-turn route in an intersection as text and output the color information at one side of a crosswalk traffic lights image in the front view camera image, if the driving route of the vehicle is the right-turn route.

According to an embodiment, the apparatus may be provided such that the processor may select traffic lights within a shortest distance from a vehicle as the target traffic lights for guidance, if there is no driving route data of a vehicle.

According to an embodiment, the apparatus may be provided such that the processor may control to set a vehicle mood lamp color to the same color as a color of the target traffic lights for guidance.

According to an embodiment, the apparatus may be provided such that the processor may control to adjust and output transparency of the remaining object image except for an image of the target traffic lights for guidance in the front view camera image and transparency of a background image.

According to an embodiment, the apparatus may be provided such that the processor may control to transmit the image in the front view camera image to a deep learning server, recognize traffic lights in the image using a convolutional neural network (CNN) algorithm, and receive an image on which a location of the traffic lights is displayed from the deep learning server, if extracting the target traffic lights for guidance from the image in the front view camera image. According to another aspect of the present disclosure, a method for displaying traffic light information in a vehicle includes steps of: obtaining, from a communication module, at least one of vehicle information, infrastructure information, surrounding vehicle information, driving route information, vehicle location information, or traffic light data using vehicle-to-everything (V2X) communication; selecting, by the processor, a target traffic light for guidance; extracting, by the processor, the target traffic light for guidance from an image in a front view camera image; and overlaying and outputting, by the processor, traffic light data with the target traffic light for guidance in the front view camera image on a navigation monitor.

According to a further aspect, a method for displaying traffic light information may be provided to include obtaining vehicle information, infrastructure information, surrounding vehicle information, driving route information, vehicle location information, and at least one piece of traffic light data using vehicle-to-everything (V2X) communication, selecting target traffic lights for guidance, extracting the target traffic lights for guidance from an image in a front view camera image, and overlaying and outputting the traffic light data with one side of the target traffic lights for guidance in the front view camera image on a navigation monitor.

According to an embodiment, the method may be provided to further include receiving driving route data of a vehicle.

According to an embodiment, the method may be provided to further include outputting at least one of traffic lights color information or a red light message at one side of first traffic lights in front of the vehicle, if a driving route of the vehicle is a straight route and the first traffic lights are a red light.

According to an embodiment, the method may be provided to further include outputting red light remaining time information of the first traffic lights together at the one side of the first traffic lights.

According to an embodiment, the method may be provided to further include highlighting and outputting an image of second traffic lights which change before the first traffic lights change to a green light.

According to an embodiment, the method may be provided to further include generating traffic lights color information of a crosswalk located on a right-turn route in an intersection as text and outputting the color information at one side of a crosswalk traffic lights image in the front view camera image, if the driving route of the vehicle is the right-turn route.

According to an embodiment, the method may be provided to further include selecting traffic lights within a shortest distance from a vehicle as the target traffic lights for guidance, if there is no driving route data of a vehicle.

According to an embodiment, the method may be provided to further include setting a vehicle mood lamp color to the same color as a color of the target traffic lights for guidance.

According to an embodiment, the method may be provided to further include adjusting and outputting transparency of the remaining object image except for an image of the target traffic lights for guidance in the front view camera image and transparency of a background image.

According to an embodiment, the method may be provided such that the extracting of the target traffic lights for guidance from the image in the front view camera image may include transmitting the image in the front view camera image to a deep learning server and recognizing traffic lights in the image using a convolutional neural network (CNN) algorithm and receiving an image on which a location of the traffic lights is displayed from the deep learning server.

### BRIEF DESCRIPTION OF THE DRAWINGS

The above and other objects, features and advantages of the present disclosure will be more apparent from the following detailed description taken in conjunction with the accompanying drawings:

FIG. 1 is a drawing for describing a configuration of an apparatus for displaying traffic light information according to an embodiment of the present disclosure;

FIG. 2 illustrates a configuration diagram of a general vehicle-to-everything (V2X) system;

FIG. 3 is a drawing for describing a process of detecting a traffic lights image according to an embodiment of the present disclosure;

FIGS. 4 and 5 are drawings for describing a process of displaying traffic light information according to an embodiment of the present disclosure;

FIGS. 6-10 are drawings for describing a process of displaying traffic light information according to another embodiment of the present disclosure;

FIG. 11 is a drawing for describing an example in which an apparatus for displaying traffic light information displays the traffic light information according to another embodiment of the present disclosure;

FIG. 12 is a flowchart for describing a method for displaying traffic light information according to an embodiment of the present disclosure;

FIG. 13 is a flowchart for describing a method for displaying traffic light information according to another embodiment of the present disclosure; and

FIG. 14 illustrates a computing system according to an embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, some embodiments of the present disclosure will be described in detail with reference to the exemplary drawings. In adding the reference numerals to the components of each drawing, it should be noted that the identical component is designated by the identical numerals even when they are displayed on other drawings. Further, in describing the embodiment of the present disclosure, a detailed description of well-known features or functions will be ruled out in order not to unnecessarily obscure the gist of the present disclosure.

In describing the components of the embodiment of the present disclosure, terms such as first, second, “A”, “B”, (a), (b), and the like may be used. These terms are only used to distinguish one component from another component, but do not limit the corresponding components irrespective of the order or priority of the corresponding components. Furthermore, unless otherwise defined, all terms including technical and scientific terms used herein have the same meaning as being generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

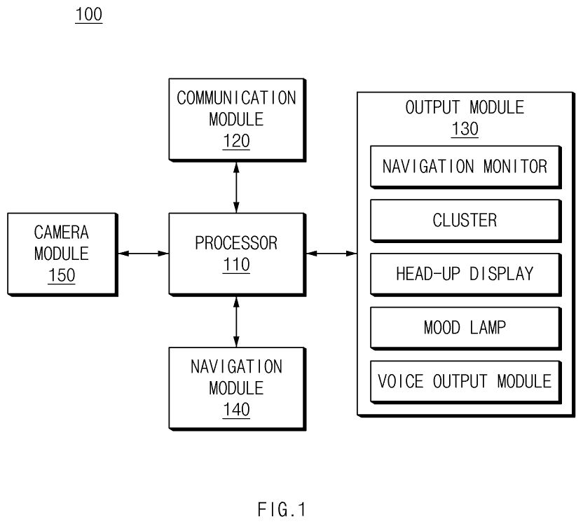

Hereinafter, embodiments of the present disclosure will be described in detail with reference to FIGS. 1 to 14.

FIG. 1 is a drawing for describing a configuration of an apparatus for displaying traffic light information according to an embodiment of the present disclosure.

As shown in FIG. 1, an apparatus 100 for displaying traffic light information may include a communication module 120 for receiving vehicle information, infrastructure information, surrounding vehicle information, driving route information, vehicle location information, and at least one piece of traffic light data using vehicle-to-everything (V2X) communication, a camera module 150 for receiving a front view camera image, an output module 130 for displaying the traffic light data on a display, and a processor 110 for selecting target traffic lights for guidance, extracting the target traffic lights for guidance from an image in the front view camera image, and overlaying and outputting the traffic light data with one side of the target traffic lights for guidance in the front view camera image on a navigation monitor.

A communication network supported by the communication module 120 may include both a wired network and a wireless network, which may be collectively called a communication network for supporting various communication specifications and protocols for pairing and/or data transmission and reception between an electronic device and a server, which support traffic infrastructure data.

Such a wired/wireless network may include all communication networks which are currently supported or will be supported in the future by the specification and may support all of one or more communication protocols for them.

For example, the wired/wireless network may be formed by a network for a wired connection, such as a universal serial bus (USB), a composite video banking sync (CVBS), a component, an S-video (analog), a digital visual interface (DVI), a high definition multimedia interface (HDMI), RGB, or D-SUB, and a communication specification and protocol for it and a network for a wireless connection, such as Bluetooth, radio frequency identification (RFID), infrared data association (IrDA), ultra wideband (UWB), ZigBee, digital living network alliance (DLNA), wireless LAN (WLAN) (Wi-Fi), wireless broadband (WiBro), world interoperability for microwave access (WiMAX), high speed downlink packet access (HSDPA), long term evolution/long term evolution-advanced (LTE/LTE-A), or Wi-Fi Direct, and a communication specification and protocol for it.

Furthermore, the communication module 120 may include a wireless Internet module, a short range communication module, or the like.

The wireless Internet module may refer to a module for wireless Internet access, which is configured to transmit and receive a wireless signal in a communication network according to wireless Internet technologies.

The wireless Internet technology may be, for example, a wireless LAN (WLAN), wireless-fidelity (Wi-Fi), Wi-Fi Direct, digital living network alliance (DLNA), wireless broadband (WiBro), world interoperability for microwave access (WiMAX), high speed downlink packet access (HSDPA), high speed uplink packet access (HSUPA), long term evolution (LTE), long term evolution-advanced (LTE-A), or the like. The wireless Internet module may transmit and receive data depending on at least one wireless Internet technology in the range of including an Internet technology which is not listed above.

From the point of view of performing the wireless Internet access by WiBro, HSDPA, HSUPA, GSM, CDMA, WCDMA, LTE, LTE-A, or the like over a mobile communication network, the wireless Internet module for performing the wireless Internet access over the mobile communication network may be understood as a kind of the mobile communication module.

The short range communication module may be for short range communication, which may support short range communication, using at least one of Bluetooth™, radio frequency identification (RFID), infrared data association (IrDA), ultra wideband (UWB), ZigBee, near field communication (NFC), wireless-fidelity (Wi-Fi), Wi-Fi Direct, and wireless universal serial bus (USB) technologies.

The processor 110 of the apparatus 100 may be composed of one or more cores and may include a processor for data analysis and deep learning, for example, a central processing unit (CPU) of a computing device, a general purpose graphics processing unit (GPGPU), or a tensor processing unit (TPU).

The traffic light data may include an ON/OFF state of traffic lights, a remaining time of the traffic lights, and ON/OFF order information of the traffic lights.

The processor 110 may control to highlight the periphery of the extracted traffic lights image.

If overlaying and outputting the traffic light data, the processor 110 may control to output the ON/OFF state and the remaining time information of the traffic lights together as voice.

If the remaining time of the traffic lights in the traffic light data is 5 seconds, the processor 110 may control to output the remaining time information together as voice again.

The apparatus 100 may include a navigation module 140 for receiving driving route data of the vehicle.

If the driving route of the vehicle is a straight route and first traffic lights in front of the vehicle are a red light, the processor 110 may control to output at least one of traffic lights color information or a red light message at one side of the first traffic lights.

The processor 110 may control to output red light remaining time information of the first traffic lights together at the one side of the first traffic lights.

The processor 110 may control to output a remaining time until the first traffic lights change to a green light together at the other side of the first traffic lights.

The processor 110 may control to highlight and output an image of second traffic lights which change before the first traffic lights change to the green light.

The processor 110 may control to generate color information of the second traffic lights as text and output the color information at one side of the second traffic lights.

The processor 110 may control to output remaining time information of the second traffic lights at the other side of the second traffic lights.

If the driving route of the vehicle is a straight route and the first traffic lights in front of the vehicle are the green light, the processor 110 may control to output at least one of traffic lights color information or a green light message at one side of the first traffic lights.

The processor 110 may control to output remaining time information of the green light of the first traffic lights at the other side of the first traffic lights.

The processor 110 may control to output a remaining time until the first traffic lights change to the red light together at the other side of the first traffic lights.

The processor 110 may calculate an average speed of a forward vehicle, may determine a distance from a current vehicle location to a stop line of the first traffic lights, and may calculate a recommended speed for passing through the stop line of the first traffic lights within the remaining time of the green light of the first traffic lights.

If the recommended speed is less than or equal to a lane speed limit and the average speed of the forward vehicle, the processor 110 may control to overlay and output recommended speed information with the other side of the first traffic lights on a navigation monitor.

If the recommended speed is greater than at least one of the lane speed limit or the average speed of the forward vehicle, the processor 110 may control to output the message that the vehicle is unable to pass through the stop line within the remaining time of the first traffic lights on the navigation monitor.

If the driving route of the vehicle is a left-turn route and the first traffic lights in front of the vehicle are the red light, the processor 110 may control to output at least one of traffic lights color information or a red light message at one side of the first traffic lights.

The processor 110 may control to output red light remaining time information of the first traffic lights together at the one side of the first traffic lights.

The processor 110 may control to output a remaining time until the first traffic lights change to a left-turn signal together at the other side of the first traffic lights.

The processor 110 may control to highlight and output an image of third traffic lights which change before the first traffic lights change to the left-turn signal.

The processor 110 may control to generate color information of the third traffic lights as text and output the color information at one side of the third traffic lights.

The processor 110 may control to output remaining time information of the third traffic lights at the other side of the third traffic lights.

If the driving route of the vehicle is a left-turn route and the first traffic lights in front of the vehicle are the left-turn signal, the processor 110 may control to output at least one of traffic lights color information or a left-turn signal message at one side of the first traffic lights.

The processor 110 may control to output remaining time information of the left-turn signal of the first traffic lights at the other side of the first traffic lights.

The processor 110 may calculate an average speed of the forward vehicle, may determine a distance from a current vehicle location to a stop line of the first traffic lights, and may calculate a recommended speed for passing through the stop line of the first traffic lights within the remaining time of the left-turn signal of the first traffic lights.

If the recommended speed is less than or equal to a lane speed limit and the average speed of the forward vehicle, the processor 110 may control to overlay and output recommended speed information with the other side of the first traffic lights on the navigation monitor.

If the recommended speed is greater than at least one of the lane speed limit or the average speed of the forward vehicle, the processor 110 may control to output the message that the vehicle is unable to pass through the stop line within the remaining time of the first traffic lights on the navigation monitor.

If the driving route of the vehicle is a right-turn route, the processor 110 may control to generate traffic lights color information of a crosswalk located on the right-turn route in an intersection as text and output the color information at one side of a crosswalk traffic lights image in the front view camera image.

If there is no driving route data of the vehicle, the processor 110 may select traffic lights within the shortest distance from the vehicle as target traffic lights for guidance.

The processor 110 may control to set a vehicle mood lamp color to the same color as the color of the target traffic lights for guidance.

The processor 110 may control to output an ON/OFF state of the target traffic lights for guidance and remaining time information of the target traffic lights for guidance on a cluster of the vehicle.

The processor 110 may control to output the ON/OFF state of the target traffic lights for guidance and the remaining time information of the target traffic lights for guidance on a head-up display (HUD) of the vehicle.

The processor 110 may control to adjust and output transparency of the remaining object image except for the image of the target traffic lights for guidance in the front view camera image and transparency of a background image.

Only if the distance between the vehicle and the target traffic lights for guidance is within a predetermined distance, the processor 110 may control to adjust and output transparency.

The processor 110 may control to enlarge and output the image of the target traffic lights for guidance in the front view camera image at predetermined magnification.

If enlarging and outputting the traffic lights image, the processor 110 may control to output the traffic lights image again at an original size after a predetermined time elapses.

Only if the distance between the vehicle and the target traffic lights for guidance is within the predetermined distance, the processor 110 may control to enlarge and output the traffic lights image.

If obtaining at least one piece of traffic light data, the processor 110 may obtain all pieces of traffic light data within a predetermined distance from the vehicle.

If extracting the target traffic lights for guidance from the image in the front view camera image, the processor 110 may control to transmit the image in the front view camera image to a deep learning server, recognize traffic lights in the image using a convolutional neural network (CNN) algorithm, and receive an image on which a location of the traffic lights is displayed from the server.

If extracting the target traffic lights for guidance from the image in the front view camera image, the processor 110 may recognize the traffic lights in the image in the front view camera image using the CNN algorithm and may extract the image on which the location of the traffic lights is displayed.

In the embodiment described above, the processor 110 may control at least one of the communication module 120, the output module 130, the navigation module 140, or the camera module 150. Furthermore, as the communication module 120, the output module 130, the navigation module 140, and the camera module 150 automatically operate without control of the processor 110 depending on a predetermined setting value, the operation described in the embodiment may be performed.

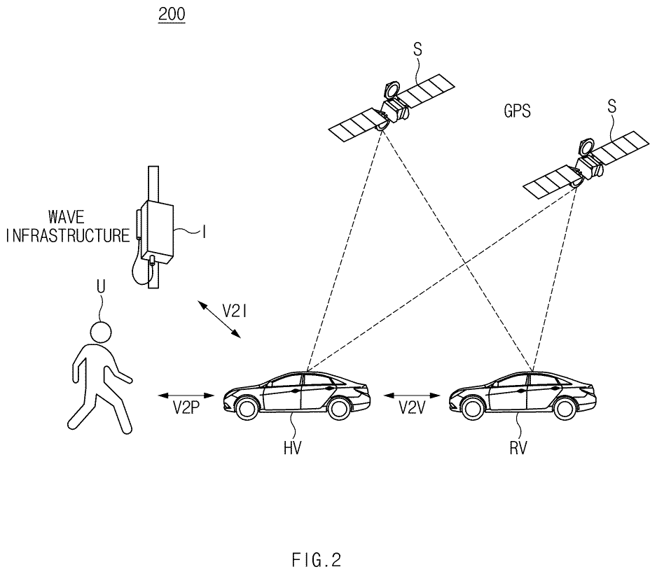

FIG. 2 illustrates a configuration diagram of a general vehicle-to-everything (V2X) system.

A V2X system 200 may be a system for providing a V2X communication-based safety and convenience function. A V2X communication technology may be a communication technology for exchanging information, such as traffic information, with another vehicle and a thing in which an infrastructure, such as a road, is constructed, over a wired/wireless network while driving.

The V2X communication may include vehicle-to-infra (V2I) communication, vehicle-to-vehicle (V2V) communication, in-vehicle networking (IVN), vehicle-to-pedestrian (V2P) communication, or the like.

An infrastructure I may collect construction section, intersection and traffic light information and information about a road risk situation or the like and may generate MAP and signal phase and timing (SPaT) messages defined in the society of automotive engineers (SAE) J2735 standard. The infrastructure I may broadcast a message generated based on wireless access in vehicular environment (WAVE) communication. In other words, the infrastructure I may transmit the MAP message (or MAP information or intersection information) and the SPaT message (or SPaT information or traffic light information) using V2I communication.

A vehicle HV may check its own location using a signal transmitted from a global positioning system (GPS) satellite S and may check a vehicle state via IVN. The vehicle HV may share a vehicle state (or vehicle information) and vehicle location information with a surrounding vehicle RV using V2V communication. The vehicle HV may share a vehicle state and vehicle location information of the surrounding vehicle RV.

An electronic device (e.g., a smartphone) may be a device capable of being carried by a pedestrian U, which may obtain pedestrian location information by means of a GPS module and may provide the vehicles HV and RV via V2P communication.

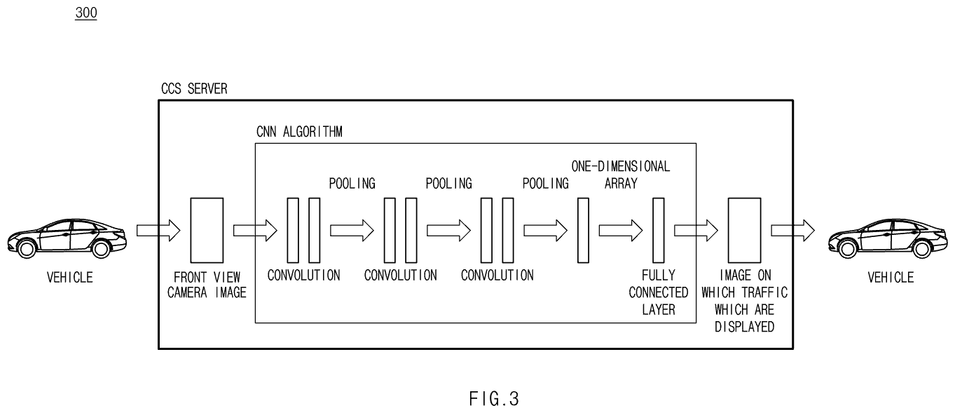

FIG. 3 is a drawing for describing a process of detecting a traffic lights image according to an embodiment of the present disclosure.

If extracting target traffic lights for guidance from an image in a front view camera image, a processor of an apparatus for displaying traffic light information may control to transmit the image in the front view camera image to a deep learning server 300, recognize traffic lights in the image using a convolutional neural network (CNN) algorithm, and receive an image on which a location of the traffic lights is displayed from the deep learning server 300.

Furthermore, if extracting the target traffic lights for guidance from the image in the front view camera image, the processor of the apparatus for displaying the traffic light information according to an embodiment of the present disclosure may recognize the traffic lights in the image in the front view camera image using the CNN algorithm and may extract the image on which the location of the traffic lights is displayed.

The processor of the apparatus for displaying the traffic light information according to an embodiment of the present disclosure may extract a plurality of vehicles, traffic lights, a pedestrian, or the like from the image in the front view camera image using the CNN algorithm.

For reference, the CNN is a kind of a deep neural network (DNN), which is a neural network composed of one or several convolutional layers, a pooling layer, and a fully connected layer.

Such a CNN has a structure suitable for learning two-dimensional data and is one of representative models of the DNN, which may be trained by means of a backpropagation algorithm and may be widely used in various application fields, such as object classification and object detection in an image. At this time, the backpropagation algorithm is a learning algorithm which has a multilayer and is used in a feedforward neural network. Supervised learning is applied to the backpropagation algorithm as a learning scheme.

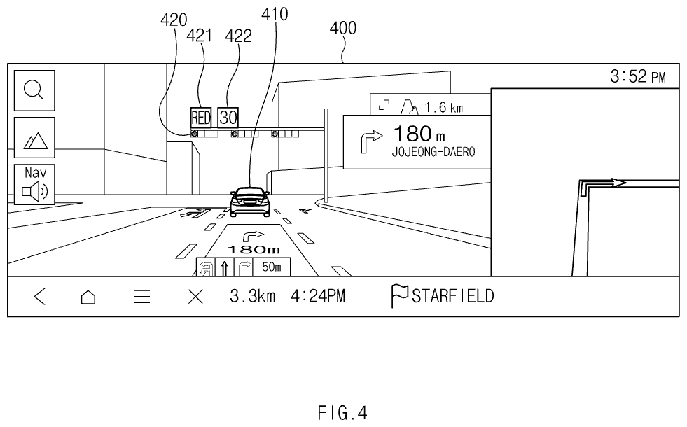

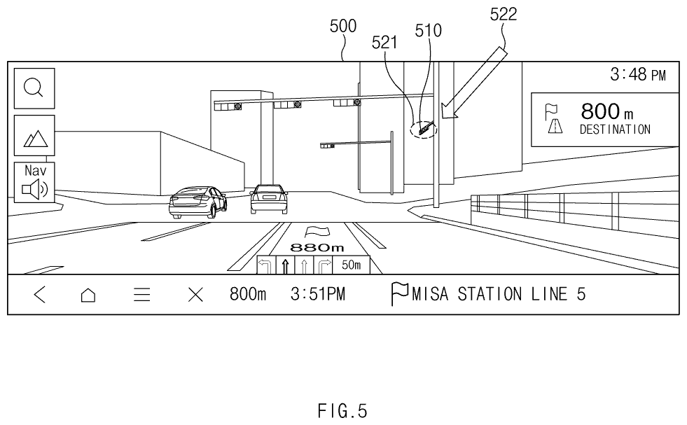

FIGS. 4 and 5 are drawings for describing a process of displaying traffic light information according to an embodiment of the present disclosure.

An apparatus 400 for displaying traffic light information according to an embodiment of the present disclosure may include a communication module for receiving vehicle information, infrastructure information, surrounding vehicle information, driving route information, vehicle location information, and at least one piece of traffic light data using V2X communication, a camera module for receiving a front view camera image, an output module for displaying the traffic light data on a display, and a processor for selecting target traffic lights for guidance, extracting the target traffic lights for guidance from an image in the front view camera image, and overlaying and outputting the traffic light data with one side of the target traffic lights for guidance in the front view camera image on a navigation monitor.

The traffic light data may include an ON/OFF state of traffic lights, a remaining time of the traffic lights, and ON/OFF order information of the traffic lights.

The processor may control to highlight the periphery of the extracted traffic lights image.

If overlaying and outputting the traffic light data, the processor may control to output the ON/OFF state and the remaining time information of the traffic lights together as voice.

If the remaining time of the traffic lights in the traffic light data is 5 seconds, the processor may control to output the remaining time information as voice again.

Furthermore, the processor of the apparatus 400 for displaying the traffic light information may extract an image of a surrounding vehicle 410 and an image of first traffic lights 420 located in front of the surrounding vehicle 410 from a front view camera image received via a camera module.

The processor may control to display traffic lights color information 421 and traffic lights remaining time information 422 as text at one side of the first traffic lights 420. At this time, the processor may control to output the traffic lights remaining time information 422 in the form of changing in real time.

A location and a size at which the traffic lights color information 421 and the traffic lights remaining time information 422 may be preset by a user.

Furthermore, a processor of an apparatus 500 for displaying traffic light information according to an embodiment of the present disclosure may control to highlight (521 and 522) the periphery of an image of second traffic lights 510 which changes before an ON/OFF state of first traffic lights located in front on a driving route of the target traffic lights 510 for guidance.

If there is no driving route data of the vehicle, the processor may select traffic lights within the shortest distance from the vehicle as target traffic lights for guidance.

The processor may control to set a vehicle mood lamp color to the same color as the color of the target traffic lights for guidance.

The processor may control to output an ON/OFF state of the target traffic lights for guidance and remaining time information of the target traffic lights for guidance on a cluster of the vehicle.

The processor may control to output the ON/OFF state of the target traffic lights for guidance and the remaining time information of the target traffic lights for guidance on a head-up display (HUD) of the vehicle.

The processor may control to adjust and output transparency of the remaining object image except for the image of the target traffic lights for guidance in the front view camera image and transparency of a background image.

Only if the distance between the vehicle and the target traffic lights for guidance is within a predetermined distance, the processor may control to adjust and output transparency.

The processor may control to enlarge and output the image of the target traffic lights for guidance in the front view camera image at predetermined magnification.

If enlarging and outputting the traffic lights image, the processor may control to output the traffic lights image again at an original size after a predetermined time elapses.

Only if the distance between the vehicle and the target traffic lights for guidance is within the predetermined distance, the processor may control to enlarge and output the traffic lights image.

If obtaining at least one piece of traffic light data, the processor may obtain all pieces of traffic light data within the predetermined distance from the vehicle.

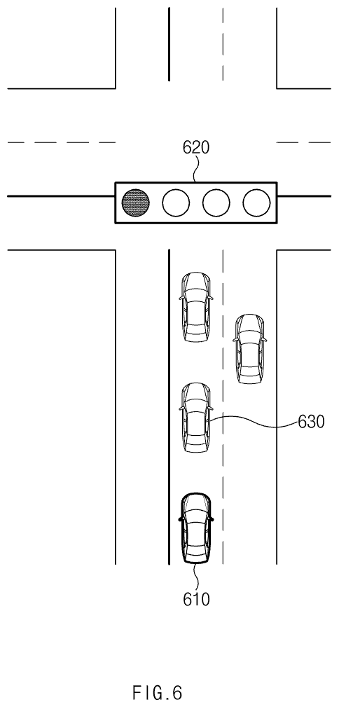

FIGS. 6 to 10 are drawings for describing a process of displaying traffic light information according to another embodiment of the present disclosure.

An apparatus for displaying traffic light information according to another embodiment of the present disclosure may include a communication module for receiving vehicle information, infrastructure information, surrounding vehicle information, driving route information, vehicle location information, and at least one piece of traffic light data using V2X communication, a camera module for receiving a front view camera image, an output module for displaying the traffic light data on a display, a processor for controlling to select target traffic lights for guidance, extract the target traffic lights for guidance from an image in the front view camera image, and overlay and output the traffic light data with one side of the target traffic lights for guidance in the front view camera image on a navigation monitor, and a navigation module for receiving driving route data of a vehicle.

As shown in FIG. 6, if a driving route of a vehicle 610 is a straight route and first traffic lights 620 in front of the vehicle 610 is a red light, the processor of the apparatus may control to output at least one of traffic lights color information or a red light message at one side of the first traffic lights 620.

The processor may control to output red light remaining time information of the first traffic lights 620 together at the one side of the first traffic lights 620.

The processor may control to output a remaining time until the first traffic lights 620 change to a green light together at the other side of the first traffic lights 620.

The processor may control to highlight and output an image of second traffic lights which change before the first traffic lights 620 change to the green light.

The processor may control to generate color information of the second traffic lights as text and output the color information at one side of the second traffic lights.

The processor may control to output remaining time information of the second traffic lights at the other side of the second traffic lights.

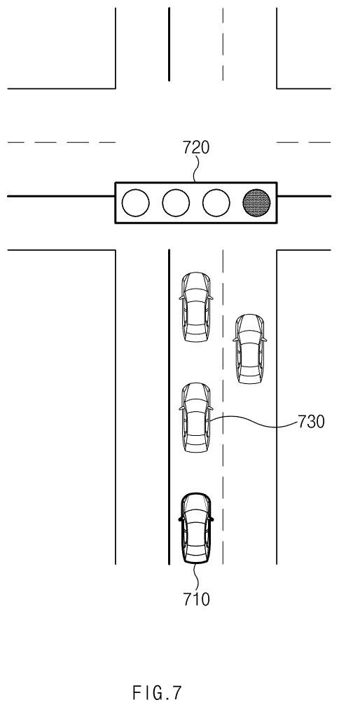

As shown in FIG. 7, if a driving route of a vehicle 710 is a straight route and first traffic lights 720 in front of the vehicle 710 is a green light, the processor of the apparatus may control to output at least one of traffic lights color information or a green light message at one side of the first traffic lights 720.

The processor may control to output remaining time information of the green light of the first traffic lights 720 at the other side of the first traffic lights 720.

The processor may control to output a remaining time until the first traffic lights 720 change to a red light together at the other side of the first traffic lights 720.

The processor may calculate an average speed of a forward vehicle 730, may determine a distance from a current location of the vehicle 710 to a stop line of the first traffic lights 720, and may calculate a recommended speed for passing through the stop line of the first traffic lights 720 within the remaining time of the green light of the first traffic lights 720.

If the recommended speed is less than or equal to a lane speed limit and the average speed of the forward vehicle 730, the processor may control to overlay and output recommended speed information with the other side of the first traffic lights 720 on a navigation monitor.

If the recommended speed is greater than at least one of the lane speed limit or the average speed of the forward vehicle 730, the processor may control to output the message that the vehicle 710 is unable to pass through the stop line within the remaining time of the first traffic lights 720 on the navigation monitor.

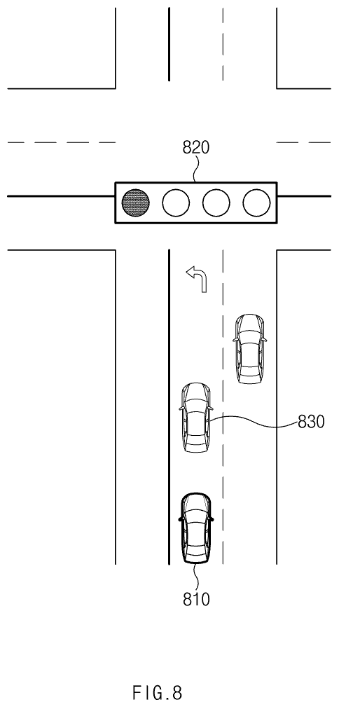

As shown in FIG. 8, if a driving route of a vehicle 810 is a left-turn route and first traffic lights 820 in front of the vehicle 810 is a red light, the processor of the apparatus may control to output at least one of traffic lights color information or a red light message at one side of the first traffic lights 820.

The processor may control to output red light remaining time information of the first traffic lights 820 together at the one side of the first traffic lights 820.

The processor may control to output a remaining time until the first traffic lights 820 change to a left-turn signal together at the other side of the first traffic lights 820.

The processor may control to highlight and output an image of third traffic lights which change before the first traffic lights 820 change to the left-turn signal.

The processor may control to generate color information of the third traffic lights as text and output the color information at one side of the third traffic lights.

The processor may control to output remaining time information of the third traffic lights at the other side of the third traffic lights.

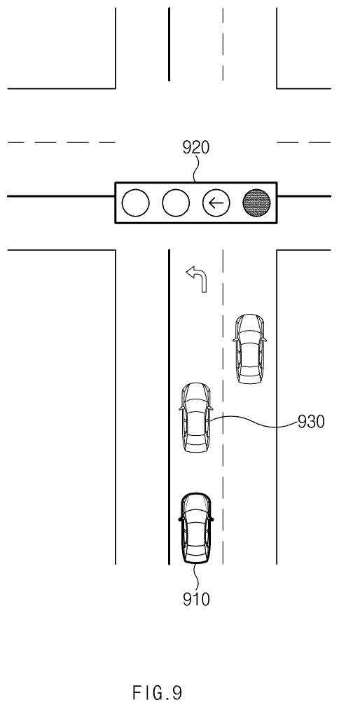

As shown in FIG. 9, if a driving route of a vehicle 910 is a left-turn route and first traffic lights 920 in front of the vehicle 910 is a left-turn signal, the processor of the apparatus may control to output at least one of traffic lights color information or a left-turn signal message at one side of the first traffic lights 920.

The processor may control to output remaining time information of the left-turn signal of the first traffic lights 920 at the other side of the first traffic lights 920.

The processor may calculate an average speed of a forward vehicle 930, may determine a distance from a current location of the vehicle 910 to a stop line of the first traffic lights 920, and may calculate a recommended speed for passing through the stop line of the first traffic lights 920 within the remaining time of the left-turn signal of the first traffic lights 920.

If the recommended speed is less than or equal to a lane speed limit and the average speed of the forward vehicle 930, the processor may control to overlay and output recommended speed information with the other side of the first traffic lights 920 on a navigation monitor.

If the recommended speed is greater than at least one of the lane speed limit or the average speed of the forward vehicle 930, the processor may control to output the message that the vehicle 910 is unable to pass through the stop line within the remaining time of the first traffic lights 920 on the navigation monitor.

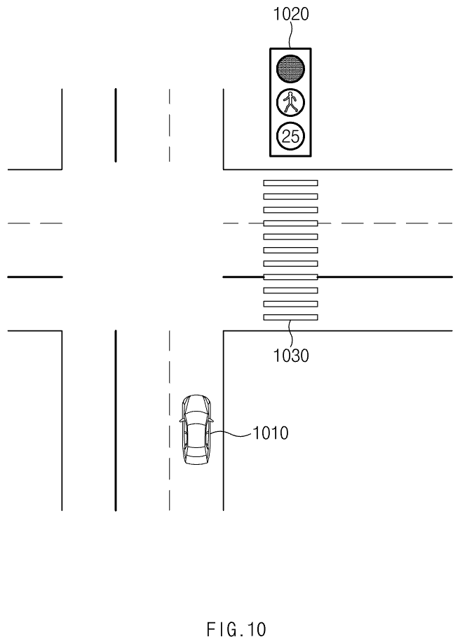

As shown in FIG. 10, if a driving route of a vehicle 1010 is a right-turn route, the processor of the apparatus may control to generate traffic lights color information of a crosswalk 1030 located on the right-turn route in an intersection as text and output the traffic lights color information at one side of a crosswalk traffic lights image 1020 in a front view camera image.

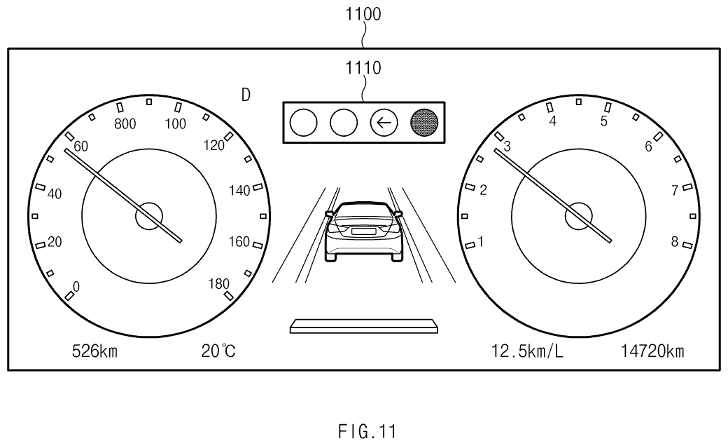

FIG. 11 is a drawing for describing an example in which an apparatus for displaying traffic light information displays the traffic light information according to another embodiment of the present disclosure.

As shown in FIG. 11, an apparatus for displaying traffic light information according to another embodiment of the present disclosure may include a communication module for receiving vehicle information, infrastructure information, surrounding vehicle information, driving route information, vehicle location information, and at least one piece of traffic light data using V2X communication, a camera module for receiving a front view camera image, an output module for displaying the traffic light data on a display, and a processor for controlling to select target traffic lights for guidance, extract the target traffic lights for guidance from an image in the front view camera image, and overlay and output the traffic light data with one side of the target traffic lights for guidance in the front view camera image on a navigation monitor.

The output module may include a navigation monitor, a cluster, a head-up display (HUD), a mood lamp, and a voice output module.

The processor may control to output traffic light information on at least one of the cluster, the HUD, the mood lamp, or the voice output module together while displaying the traffic light information on the navigation monitor.

The processor may control to set a vehicle mood lamp color to the same color as a color of the target traffic lights for guidance.

The processor control to output an ON/OFF state 1110 of the target traffic lights for guidance and remaining time information of the target traffic lights for guidance on a cluster 1100 of a vehicle.

The processor may control to output the ON/OFF state of the target traffic lights for guidance and the remaining time information of the target traffic lights for guidance on an HUD of the vehicle.

The processor may control to adjust and output transparency of the remaining object image except for the image of the target traffic lights for guidance in the front view camera image and transparency of a background image.

Only if the distance between the vehicle and the target traffic lights for guidance is within a predetermined distance, the processor may control to adjust and output transparency.

The processor may control to enlarge and output the image of the target traffic lights for guidance in the front view camera image at predetermined magnification.

If enlarging and outputting the traffic lights image, the processor may control to output the traffic lights image again at an original size after a predetermined time elapses.

Only if the distance between the vehicle and the target traffic lights for guidance is within the predetermined distance, the processor may control to enlarge and output the traffic lights image.

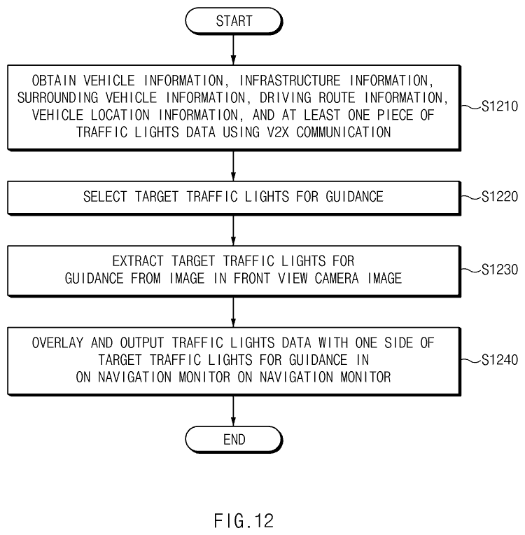

FIG. 12 is a drawing for describing a method for displaying traffic light information according to an embodiment of the present disclosure.

The method for displaying the traffic light information according to an embodiment of the present disclosure may include obtaining (S1210) vehicle information, infrastructure information, surrounding vehicle information, driving route information, vehicle location information, and at least one piece of traffic light data using V2X communication, selecting (S1220) target traffic lights for guidance, extracting (S1230) the target traffic lights for guidance from an image in a front view camera image, and overlaying and outputting (S1240) the traffic light data with one side of the target traffic lights for guidance in the front view camera image on a navigation monitor.

The traffic light data may include an ON/OFF state of traffic lights, a remaining time of the traffic lights, and ON/OFF order information of the traffic lights. The periphery of the extracted traffic lights image may be highlighted.

If the traffic light data is overlaid and output, the ON/OFF state and the remaining time information of the traffic lights may be output together as voice.

If the remaining time of the traffic lights in the traffic light data is 5 seconds, the remaining time information may be output together as voice again.

If there is no driving route data of the vehicle, traffic lights within the shortest distance from the vehicle may be selected as the target traffic lights for guidance.

The method for displaying the traffic light information may further include setting a vehicle mood lamp color to the same color as a color of the target traffic lights for guidance.

An ON/OFF state of the target traffic lights for guidance and remaining time information of the target traffic lights for guidance may be output on a cluster of the vehicle.

The ON/OFF state of the target traffic lights for guidance and the remaining time information of the target traffic lights for guidance may be output on an HUD of the vehicle.

The method for displaying the traffic light information may further include adjusting and outputting transparency of the remaining object image except for the image of the target traffic lights for guidance in the front view camera image and transparency of a background image.

Only if the distance between the vehicle and the target traffic lights for guidance is within a predetermined distance, transparency may be adjusted and output.

The method for displaying the traffic light information may further include enlarging and outputting the image of the target traffic lights for guidance in the front view camera image at a predetermined magnification.

If the traffic lights image is enlarged and output, it may be output again at an original size after a predetermined time elapses.

Only if the distance between the vehicle and the target traffic lights for guidance is within the predetermined distance, the traffic lights image may be enlarged and output.

The obtaining of the at least one piece of traffic light data may include obtaining all pieces of traffic light data within a predetermined distance from the vehicle.

The extracting of the target traffic lights for guidance from the image in the front view camera image may include transmitting the image in the front view camera image to a deep learning server and recognizing traffic lights in the image using a CNN algorithm and receiving an image on which a location of the traffic lights is displayed from the deep learning server.

The extracting of the target traffic lights for guidance from the image in the front view camera image may include recognizing the traffic lights in the image in the front view camera image using the CNN algorithm and extracting the image on which the location of the traffic lights is displayed.

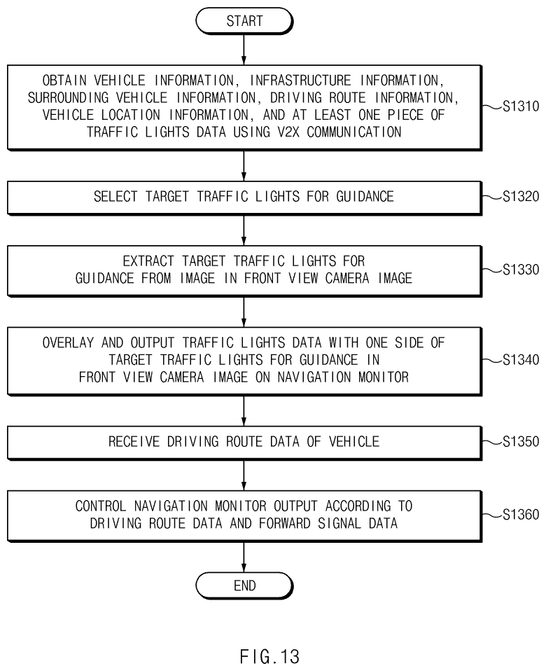

FIG. 13 is a drawing for describing a method for displaying traffic light information according to another embodiment of the present disclosure.

The method for displaying the traffic light information according to another embodiment of the present disclosure may include obtaining (S1310) vehicle information, infrastructure information, surrounding vehicle information, driving route information, vehicle location information, and at least one piece of traffic light data using V2X communication, selecting (S1320) target traffic lights for guidance, extracting (S1330) the target traffic lights for guidance from an image in a front view camera image, overlaying and outputting (S1340) the traffic light data with one side of the target traffic lights for guidance in the front view camera image on a navigation monitor, receiving (S1350) driving route data of a vehicle, and controlling (S1360) a navigation monitor output according to the driving route data and forward signal data.

In detail, if the driving route of the vehicle is a straight route and first traffic lights in front of the vehicle are a red light, at least one of traffic lights color information or a red light message may be output at one side of the first traffic lights.

Red light remaining time information of the first traffic lights may be output together at the one side of the first traffic lights.

A remaining time until the first traffic lights change to a green light may be output together at the other side of the first traffic lights.

An image of second traffic lights which changes before the first traffic lights change to the green light may be highlighted and output.

Color information of the second traffic lights may be generated as text and may be output at one side of the second traffic lights.

Remaining time information of the second traffic lights may be output at the other side of the second traffic lights.

If the driving route of the vehicle is a straight route and the first traffic lights in front of the vehicle are the green light, at least one of traffic lights color information or a green light message may be output at one side of the first traffic lights.

Remaining time information of the green light of the first traffic lights may be output at the other side of the first traffic lights.

A remaining time until the first traffic lights change to a red light may be output together at the other side of the first traffic lights.

Furthermore, the method for displaying the traffic light information may include calculating an average speed of a forward vehicle, determining a distance from a current vehicle location to a stop line of the first traffic lights, and calculating a recommended speed for passing through the stop line of the first traffic lights within the remaining time of the green light of the first traffic lights.

If the recommended speed is less than or equal to a lane speed limit and the average speed of the forward vehicle, recommended speed information may be overlaid and output with the other side of the first traffic lights on the navigation monitor.

If the recommended speed is greater than at least one of the lane speed limit or the average speed of the forward vehicle, the message that the vehicle is unable to pass through the stop line within the remaining time of the first traffic lights may be output on the navigation monitor.

If the driving route of the vehicle is a left-turn route and the first traffic lights in front of the vehicle are the red light, at least one of traffic lights color information or a red light message may be output at one side of the first traffic lights.

Red light remaining time information of the first traffic lights may be output together at the one side of the first traffic lights.

A remaining time until the first traffic lights change to a left-turn signal may be output together at the other side of the first traffic lights.

An image of third traffic lights which change before the first traffic lights change to the left-turn signal may be highlighted and output.

Color information of the third traffic lights may be generated as text and may be output at one side of the third traffic lights.

Remaining time information of the third traffic lights may be output at the other side of the third traffic lights.

If the driving route of the vehicle is a left-turn route and the first traffic lights in front of the vehicle are the left-turn signal, at least one of traffic lights color information or a left-turn signal message may be output at one side of the first traffic lights.

Remaining time information of the left-turn signal of the first traffic lights may be output at the other side of the first traffic lights.

The method for displaying the traffic light information may include calculating an average speed of a forward vehicle, determining a distance from a current vehicle location to a stop line of the first traffic lights, and calculating a recommended speed for passing through the stop line of the first traffic lights within the remaining time of the left-turn signal of the first traffic lights.

If the recommended speed is less than or equal to a lane speed limit and the average speed of the forward vehicle, recommended speed information may be overlaid and output with the other side of the first traffic lights on the navigation monitor.

If the recommended speed is greater than at least one of the lane speed limit or the average speed of the forward vehicle, the message that the vehicle is unable to pass through the stop line within the remaining time of the first traffic lights may be output on the navigation monitor.

If the driving route of the vehicle is a right-turn route, traffic lights color information of a crosswalk located on the right-turn route in an intersection may be generated as text and may be output at one side of a crosswalk traffic lights image in a front view camera image.

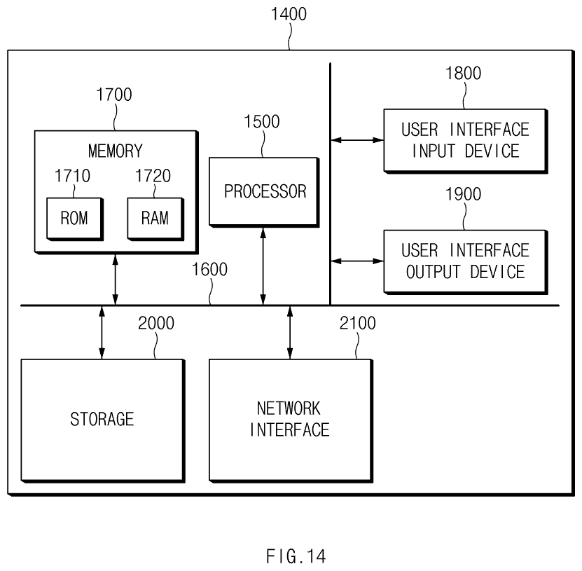

FIG. 14 illustrates a computing system according to an embodiment of the present disclosure.

Referring to FIG. 14, a computing system 1400 may include at least one processor 1500, a memory 1700, a user interface input device 1800, a user interface output device 1900, storage 2000, and a network interface 2100, which are connected with each other via a bus 1600.

The processor 1500 may be a central processing unit (CPU) or a semiconductor device that processes instructions stored in the memory 1700 and/or the storage 2000. The memory 1700 and the storage 2000 may include various types of volatile or non-volatile storage media. For example, the memory 1700 may include a read only memory (ROM) 1710 and a random access memory (RAM) 1720.

Accordingly, the operations of the method or algorithm described in connection with the embodiments disclosed in the specification may be directly implemented with a hardware module, a software module, or a combination of the hardware module and the software module, which is executed by the processor 1500. The software module may reside on a storage medium (that is, the memory 1700 and/or the storage 2000) such as a RAM, a flash memory, a ROM, an EPROM, an EEPROM, a register, a hard disc, a removable disk, and a CD-ROM.

The exemplary storage medium may be coupled to the processor 1500. The processor 1500 may read out information from the storage medium and may write information in the storage medium. Alternatively, the storage medium may be integrated with the processor 1500. The processor and the storage medium may reside in an application specific integrated circuit (ASIC). The ASIC may reside within a user terminal. In another case, the processor and the storage medium may reside in the user terminal as separate components.

The present technology may provide the method for solving the visibility program of the traffic lights displayed on the navigation monitor depending on the external environment, such as the dark night, the dark tunnel, the inside of the underpass, or the inclement weather such as the heavy rain.

Furthermore, the present technology may provide the method for allowing the color-blind driver to accurately recognize the signal information of the traffic lights in the augmented reality image displayed on the navigation monitor.

In addition, various effects ascertained directly or indirectly through the present disclosure may be provided.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

Therefore, embodiments of the present disclosure are not intended to limit the technical spirit of the present disclosure, but provided only for the illustrative purpose. The scope of the present disclosure should be construed on the basis of the accompanying claims, and all the technical ideas within the scope equivalent to the claims should be included in the scope of the present disclosure.

What is claimed is:

1. An apparatus for displaying traffic light information in a vehicle, the apparatus comprising:
a communication module configured to receive at least one of vehicle information, infrastructure information, surrounding vehicle information, driving route information, vehicle location information, or traffic light data using vehicle-to-everything (V2X) communication;
a camera module configured to receive a front view camera image;
an output module configured to display the traffic light data on a display of a vehicle; and
a processor configured to control to select at least a target traffic light for guidance, extract the target traffic light for guidance from an image in the front view camera image, and overlay and output the traffic light data with the target traffic light for guidance in the front view camera image on a navigation monitor.

2. The apparatus of claim 1, further comprising:
a navigation module configured to receive driving route data of the vehicle.

3. The apparatus of claim 2, wherein the processor is configured to:
control to output at least one of traffic light color information or a red light message at one side of a first traffic light in front of the vehicle, if a driving route of the vehicle is a straight route and the first traffic light is a red light.

4. The apparatus of claim 3, wherein the processor is configured to:
control to output red light remaining time information of the first traffic light together at the one side of the first traffic light.

5. The apparatus of claim 3, wherein the processor is configured to:
control to highlight and output an image of a second traffic light which changes before the first traffic light changes to a green light.

6. The apparatus of claim 2, wherein the processor is configured to:
control to generate the traffic light color information of a crosswalk located on a right-turn route in an intersection as text and output the color information at one side of a crosswalk traffic lights image in the front view camera image, if the driving route of the vehicle is the right-turn route.

7. The apparatus of claim 1, wherein the processor is configured to:
select a traffic light within a shortest distance from a vehicle as the target traffic light for guidance, if there is no driving route data of the vehicle.

8. The apparatus of claim 1, wherein the processor is configured to:
control to set a vehicle mood lamp color to the same color as a color of the target traffic light for guidance.

9. The apparatus of claim 1, wherein the processor is configured to:
control to adjust and output transparency of the remaining object image except for an image of the target traffic light for guidance in the front view camera image and transparency of a background image.

10. The apparatus of claim 1, wherein the processor is configured to:
control to transmit the image in the front view camera image to a deep learning server, recognize the traffic light in the image using a convolutional neural network (CNN) algorithm, and receive an image on which a location of the traffic light is displayed from the deep learning server, if extracting the target traffic light for guidance from the image in the front view camera image.

11. A method for displaying traffic light information in a vehicle, the method comprising:
obtaining, from a communication module, at least one of vehicle information, infrastructure information, surrounding vehicle information, driving route information, vehicle location information, or traffic light data using vehicle-to-everything (V2X) communication;
selecting, by the processor, a target traffic light for guidance;
extracting, by the processor, the target traffic light for guidance from an image in a front view camera image; and
overlaying and outputting, by the processor, traffic light data with the target traffic light for guidance in the front view camera image on a navigation monitor.

12. The method of claim 11, further comprising:
receiving, by a navigation module, driving route data of the vehicle.

13. The method of claim 12, further comprising:
outputting at least one of traffic light color information or a red light message at one side of a first traffic light in front of the vehicle, if a driving route of the vehicle is a straight route and the first traffic light is a red light.

14. The method of claim 13, further comprising:
outputting red light remaining time information of the first traffic light together at the one side of the first traffic light.

15. The method of claim 13, further comprising:
highlighting and outputting an image of a second traffic light which changes before the first traffic light changes to a green light.

16. The method of claim 12, further comprising:
generating traffic light color information of a crosswalk located on a right-turn route in an intersection as text and outputting the color information at one side of a crosswalk traffic lights image in the front view camera image, if the driving route of the vehicle is the right-turn route.

17. The method of claim 11, further comprising:
selecting a traffic light within a shortest distance from the vehicle as the target traffic light for guidance, if there is no driving route data of the vehicle.

18. The method of claim 11, further comprising:
setting a vehicle mood lamp color to the same color as a color of the target traffic light for guidance.

19. The method of claim 11, further comprising:
adjusting and outputting transparency of the remaining object image except for an image of the target traffic light for guidance in the front view camera image and transparency of a background image.

20. The method of claim 11, wherein extracting the target traffic light for guidance from the image in the front view camera image includes:
transmitting the image in the front view camera image to a deep learning server; and
recognizing a traffic light in the image using a convolutional neural network (CNN) algorithm and receiving an image on which a location of the traffic light is displayed from the deep learning server.
